(19) United States
(12) Patent Application Publication
(10) Pub. No.: US 2015/0133069 A1
(43) Pub. Date: May 14, 2015

(54) FM RECEIVER WITH FREQUENCY DEVIATION-DEPENDENT ADAPTIVE CHANNEL FILTER

(71) Applicant: QUALCOMM Incorporated, San Diego, CA (US)

(72) Inventors: Eunmo Kang, San Diego, CA (US); Yossef Tsfaty, Rishon-Le-Zion (IL); Le Nguyen Luong, San Diego, CA (US)

(73) Assignee: QUALCOMM Incorporated, San Diego, CA (US)

(21) Appl. No.: 14/080,551

(22) Filed: Nov. 14, 2013

(51) Int. Cl. H04B 1/12; H04L 27/14

(52) U.S. Cl. CPC H04B 1/123; H04L 27/14
USPC 455/307

(57) ABSTRACT

Methods, systems, and devices are described for wireless communications in a frequency modulation (FM) receiver with a frequency deviation-dependent adaptive channel filter. A maximum frequency deviation of an FM broadcast signal may be estimated. One or more coefficients of a channel filter may be adapted based at least in part on the maximum frequency deviation. The coefficient adaptation may include identifying a set of coefficients corresponding to the maximum frequency deviation and applying the set of coefficients to the channel filter. The set of coefficients may be identified by selecting one of multiple sets of coefficients stored in memory. In some instances, a signal quality metric (e.g., signal-to-noise ratio (SNR)) may be identified and may be used to modify a value of one or more of the set of coefficients applied to the channel filter.

### BACKGROUND

When transmitting audio and/or data broadcasting, the radio frequency (RF) broadcast signal may consist of a carrier that is frequency-modulated (FM) by the audio and/or data signal that is to be transmitted. For very high frequency (VHF) transmissions, the RF signal may have certain bandwidth requirements, also referred to as maximum frequency deviation requirements, which are different for different countries or regions of the world. For example, the maximum frequency deviation requirement may be ±75 kilohertz (kHz) in the United States and in Western European countries, while for some Eastern European countries the maximum frequency deviation requirement may be ±50 kHz (e.g., ITU-R BS.405.3). There may be other maximum frequency deviation requirements that have been either proposed or that are in use in other countries or regions (e.g., ±67.5 kHz, ±100 kHz). These varying requirements have emerged recently in part from the advent of digital FM receivers to handle FM broadcasts. The inconsistency in these requirements poses a challenge, particularly when smart phones with digital FM receivers optimized for one maximum frequency deviation are deployed in a part of the world in which another maximum frequency deviation is used.

Generally, a single channel filter is used in a digital FM receiver and the channel filter is optimized to only one of the possible maximum frequency deviations used around the world. That same digital FM receiver will operate sub-optimally with any other bandwidth. For example, a channel filter optimized for a ±50 kHz environment that instead operates in a ±75 kHz environment may see additional noise resulting in performance loss.

Because of the varying maximum frequency deviation requirements around the world, the channel filter of a digital FM receiver does not operate optimally in every country or region. Therefore, it may be desirable to have a channel filter with high (e.g., optimal or close to optimal) operating performance over a wide range of maximum frequency deviations.

### SUMMARY

The described features generally relate to one or more improved methods, apparatuses, devices, and/or systems for wireless communications. More particularly, the described features generally relate to wireless communications in which an FM receiver with frequency deviation-dependent adaptive channel filter is used for FM broadcasting.

One aspect of an FM receiver with frequency deviation-dependent adaptive channel filter includes estimating the maximum frequency deviation of an FM broadcast signal from an input of a channel filter or output of a demodulator in the FM receiver. One or more coefficients of the channel filter may be adapted based at least in part on the maximum frequency deviation. The coefficient adaptation may include identifying a set of coefficients corresponding to the maximum frequency deviation and applying the set of coefficients to the channel filter. In one example, the set of coefficients may be identified by selecting one of multiple sets of coefficients stored in memory. Each of the sets of coefficients in memory may correspond to a particular maximum frequency deviation estimate. In some instances, a signal quality metric (e.g., signal-to-noise ratio (SNR)) may be identified and may be used to modify a value of one or more of the set of coefficients applied to the channel filter.

According to at least one set of illustrative embodiments, a method for wireless communications may include estimating a maximum frequency deviation of a frequency-modulated (FM) broadcast signal and adapting one or more coefficients of a channel filter based at least in part on the maximum frequency deviation.

In certain examples, adapting one or more coefficients of a channel filter may include identifying a set of coefficients corresponding to the maximum frequency deviation and applying the set of coefficients to the channel filter.

In certain examples, identifying a set of coefficients corresponding to the maximum frequency deviation may include selecting the set of coefficients from multiple sets of coefficients stored in memory.

In certain examples, the multiple sets of coefficients may include one or more of: a set of coefficients for 22.5 kilohertz (kHz) maximum frequency deviation; a set of coefficients for 50 kHz maximum frequency deviation; a set of coefficients for 75 kHz maximum frequency deviation; and a set of coefficients for 100 kHz maximum frequency deviation.

In certain examples, identifying a set of coefficients corresponding to the maximum frequency deviation may include identifying a signal quality metric, selecting the set of coefficients from multiple sets of coefficients stored in memory, and modifying a value of one or more of the set of coefficients based at least in part on the signal quality metric.

In certain examples, modifying a value of one or more of the set of coefficients based at least in part on the signal quality metric may include performing a gradient descent-based optimization on at least a portion of the set of coefficients.

In certain examples, the method may further include estimating a first signal strength of a carrier from an input of the channel filter, estimating a second signal strength of a pilot tone from an output of the demodulator, and adapting the one or more coefficients of the channel filter based at least in part on one or both of the first and second signal strengths.

According to at least a second set of illustrative embodiments, an apparatus for wireless communications includes means for estimating a maximum frequency deviation of a frequency-modulated (FM) broadcast signal and means for adapting one or more coefficients of a channel filter based at least in part on the maximum frequency deviation.

In certain examples, the apparatus for wireless communications may implement one or more aspects of the method described above with respect to the first set of illustrative embodiments. For example, the apparatus may includes means for implementing one or more of the examples described above with respect to the first set of illustrative embodiments.

According to at least a third set of illustrative embodiments, an apparatus for wireless communications includes: a processor; memory in electronic communication with the processor; and instructions stored in the memory. The instructions may be executable by the processor to estimate a maximum frequency deviation of a frequency-modulated (FM) broadcast signal and adapt one or more coefficients of a channel filter based at least in part on the maximum frequency deviation.

In certain examples, the apparatus for wireless communications may implement one or more aspects of the method described above with respect to the first set of illustrative embodiments. For example, the memory may store instructions executable by the processor to implement one or more of the examples of the method described above with respect to the first set of illustrative embodiments.

The foregoing has outlined rather broadly the features and technical advantages of examples according to the disclosure in order that the detailed description that follows may be better understood. Additional features and advantages will be described hereinafter. The conception and specific examples disclosed may be readily utilized as a basis for modifying or designing other structures for carrying out the same purposes of the present disclosure. Such equivalent constructions do not depart from the scope of the appended claims. Features which are believed to be characteristic of the concepts disclosed herein, both as to their organization and method of operation, together with associated advantages will be better understood from the following description when considered in connection with the accompanying figures. Each of the figures is provided for the purpose of illustration and description only, and not as a definition of the limits of the claims.

### BRIEF DESCRIPTION OF THE DRAWINGS

A further understanding of the nature and advantages of the present disclosure may be realized by reference to the following drawings. In the appended figures, similar components or features may have the same reference label. Further, various components of the same type may be distinguished by following the reference label by a dash and a second label that distinguishes among the similar components. If only the first reference label is used in the specification, the description is applicable to any one of the similar components having the same first reference label irrespective of the second reference label.

FIG. 1 shows a diagram that illustrates an example of FM broadcasting at VHF according to various embodiments;

FIG. 2 shows a diagram that illustrates an example of a device with an FM receiver according to various embodiments;

FIG. 3A shows a diagram that illustrates an example of an FM receiver according to various embodiments;

FIG. 3B shows a diagram that illustrates another example of an FM receiver according to various embodiments;

FIG. 4 shows a diagram that illustrates an example of an estimator according to various embodiments;

FIG. 5 shows a diagram that illustrates an example of a filter mapper according to various embodiments;

FIG. 6 shows a diagram that illustrates an example of an intermediate frequency (IF) signal-to-noise ratio (SNR) module according to various embodiments;

FIG. 7 shows a diagram that illustrates an example of a pilot tone SNR module according to various embodiments;

FIG. 8 shows a block diagram that illustrates an example of a device for receiving FM broadcasting at VHF according to various embodiments; and

FIGS. 9-11 are flowcharts of examples of methods for adapting a channel filter in an FM receiver based on maximum frequency deviation according to various embodiments.

### DETAILED DESCRIPTION

Described embodiments are directed to methods, devices, and apparatuses for wireless communications in which an FM receiver includes a frequency deviation-dependent adaptive channel filter. The FM receiver (e.g., digital FM receiver) may be configured to estimate a maximum frequency deviation of an FM broadcast signal (e.g., VHF audio broadcast) from an input of a channel filter or output of a demodulator within the FM receiver. One or more coefficients of the channel filter may be adapted, modified, or adjusted based at least in part on the maximum frequency deviation estimate. Adapting the coefficients may include identifying a particular set of coefficients that corresponds to the estimate of the maximum frequency deviation and applying that set of coefficients to the channel filter. In one example, the set of coefficients may be identified by selecting one of multiple sets of coefficients stored in memory. Each of the sets of coefficients in memory may correspond to a particular maximum frequency deviation estimate. In some instances, a signal quality metric (e.g., carrier-to-noise ratio (CNR), pilot tone SNR) may be identified and may be used to modify a value of one or more of the set of coefficients applied to the frequency deviation-dependent adaptive channel filter.

To achieve better audio quality during FM broadcasts it may be desirable for the channel filter in the FM receiver to effectively filter out-of-band noise. The channel filter, however, may not be able to do so optimally for each possible maximum frequency deviation when the filter coefficients are optimized for a particular maximum frequency deviation (i.e., maximum bandwidth). To improve the performance of the channel filter, the coefficients of the filter may be adapted or changed by a filter mapper, which may also be referred to as a frequency deviation-to-filter mapper. The filter mapper may adjust the filter coefficients based on results (e.g., maximum frequency deviation estimates) produced by an estimator that monitors an input of a channel filter or an output of the (FM) demodulator. The estimator can make estimates of the maximum frequency deviation by tracking minimum and maximum values of the FM demodulator output. Another approach to estimating the maximum frequency deviation is to convert the input of the FM demodulator to the frequency domain (e.g., using a Fast Fourier Transform (FFT)) and determine the signal bandwidth from the frequency information. In some cases, such as when the audio signal is low for a prolonged period of time or when CNR is low, the maximum frequency deviation estimate may not be very accurate. One approach to improve the accuracy of the maximum frequency deviation estimate is to measure the estimate multiple times and compute the maximum frequency deviation estimate based on the multiple estimates (e.g., an average or the maximum value of the multiple estimates). In some embodiments, the estimator may be able to determine an error or accuracy associated with the estimate. This variance may be provided, along with the maximum frequency deviation estimate, to the filter mapper.

The filter mapper may identify a set of coefficients to be applied to the channel filter for a particular estimate of the maximum frequency deviation. Once these coefficients are applied, the channel filter may operate optimally for the maximum frequency deviation estimated by the estimator. The set of coefficients may be identified in at least a few different ways. One approach is to have multiple, pre-defined (e.g., computed off-line) sets of coefficients stored in memory (e.g., look-up table), where each of these sets is used for a particular estimate of the maximum frequency deviation. In some cases, the variance described above may be used along with the maximum frequency deviation estimate to select the appropriate set of coefficients to apply to the channel filter.

Another approach may involve selecting a set of coefficients (from multiple available sets) as a first step, and then providing a fine tuning step in which the variance and/or some other metric (e.g., CNR, pilot tone SNR) is used as part of a gradient descent-based optimization to modify the value of one or more of the set of coefficients such that the modified values provide more effective filtering than the values of the initially selected set of coefficients.

One of the advantages provided by using an adaptive channel filter in a digital FM receiver is the improved audio quality because it may now be possible to filter out the noise in a spectrum outside of the signal bandwidth.

The various techniques described herein for wireless communications are described with respect to FM broadcasting in VHF. However, the same or similar techniques may be used with FM broadcasting other than VHF and/or with different wireless communications networks, including wireless local area networks (WLAN) or Wi-Fi networks. WLAN or Wi-Fi networks may refer to a network that is based on the protocols described in the various IEEE 802.11 standards (e.g., IEEE 802.11a/g, 802.11n, 802.11ac, 802.11ah, etc.), for example. In addition, the same or similar techniques may also be used in any wireless network (e.g., a cellular network). For example, the same or similar techniques may be used for various wireless communications systems such as cellular wireless systems, Peer-to-Peer wireless communications, ad hoc networks, satellite communications systems, and other systems. The terms “system” and “network” are often used interchangeably. These wireless communications systems may employ a variety of radio communication technologies such as Code Division Multiple Access (CDMA), Time Division Multiple Access (TDMA), Frequency Division Multiple Access (FDMA), Orthogonal FDMA (OFDMA), Single-Carrier FDMA (SC-FDMA), and/or other radio technologies. Generally, wireless communications are conducted according to a standardized implementation of one or more radio communication technologies called a Radio Access Technology (RAT). A wireless communications system or network that implements a Radio Access Technology may be called a Radio Access Network (RAN).

Examples of Radio Access Technologies employing CDMA techniques include CDMA2000, Universal Terrestrial Radio Access (UTRA), etc. CDMA2000 covers IS-2000, IS-95, and IS-856 standards. IS-2000 Releases 0 and A are commonly referred to as CDMA2000 1X, 1X, etc. IS-856 (TIA-856) is commonly referred to as CDMA2000 1xEV-DO, High Rate Packet Data (HRPD), etc. UTRA includes Wideband CDMA (WCDMA) and other variants of CDMA. Examples of TDMA systems include various implementations of Global System for Mobile Communications (GSM). Examples of Radio Access Technologies employing OFDM and/or OFDMA include Ultra Mobile Broadband (UMB), Evolved UTRA (E-UTRA), Wi-Fi, IEEE 802.16 (WiMAX), IEEE 802.20, Flash-OFDM, etc. UTRA and E-UTRA are part of Universal Mobile Telecommunication System (UMTS). 3GPP Long Term Evolution (LTE) and LTE-Advanced (LTE-A) are new releases of UMTS that use E-UTRA. UTRA, E-UTRA, UMTS, LTE, LTE-A, and GSM are described in documents from an organization named “3rd Generation Partnership Project” (3GPP). CDMA2000 and UMB are described in documents from an organization named “3rd Generation Partnership Project 2” (3GPP2). The techniques described herein may be used for the systems and radio technologies mentioned above as well as other systems and radio technologies.

Thus, the following description provides examples, and is not limiting of the scope, applicability, or configuration set forth in the claims. Changes may be made in the function and arrangement of elements discussed without departing from the spirit and scope of the disclosure. Various embodiments may omit, substitute, or add various procedures or components as appropriate. For instance, the methods described may be performed in an order different from that described, and various steps may be added, omitted, or combined. Also, features described with respect to certain embodiments may be combined in other embodiments.

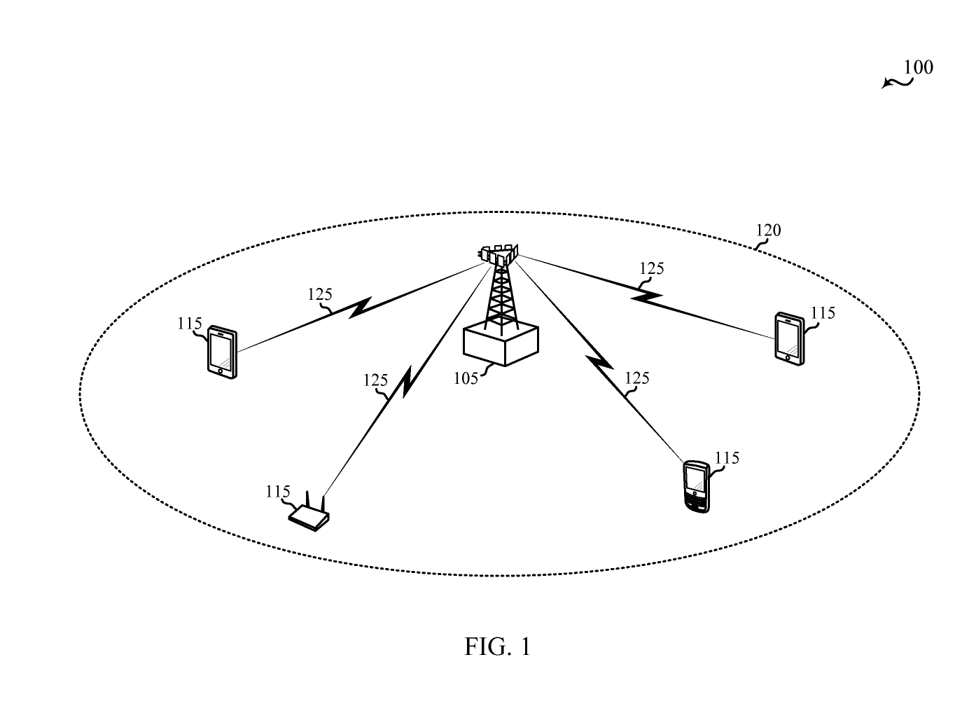

Referring to FIG. 1, a diagram 100 illustrates a transmitter 105 that broadcasts RF signals 125 to one or more terminals or stations 115. The RF signals 125 include a carrier that is frequency-modulated by an audio and/or data signal being transmitted. The transmitter 105 may be a standalone broadcasting device or may be part of a base station or an access point used in different types of wireless communications networks (e.g., cellular networks, WLANs). In some embodiments, the transmitter 105 may be configured to perform FM broadcasting in VHF (e.g., band 8). In other embodiments, the transmitter 105 may be configured to perform FM broadcasting in other bands.

The transmitter 105 may be configured to perform monophonic transmissions and/or stereophonic transmissions. For monophonic transmissions, the RF signals include a carrier that is frequency-modulated by the audio and/or data signal being transmitted after the pre-emphasis of the audio signal. The maximum frequency deviation of the RF signal may depend on the country and/or region of transmission. For example, the maximum frequency deviation requirement may be ±75 kHz in the United States and in Western European countries, while for some Eastern European countries the maximum frequency deviation requirement may be ±50 kHz. For simplicity, a maximum frequency deviation of ±75 kHz or ±50 kHz may be referred to hereinafter as a maximum frequency deviation of 75 kHz or 50 kHz, respectively.

For stereophonic transmissions, a polar-modulation system or a pilot tone system may be used. In both systems, the RF signal may consist of a carrier that is frequency-modulated by a baseband signal, which may be referred to as a stereophonic multiplex signal. The maximum frequency deviation requirement in each of these systems may be 75 kHz in the United States and in Western European countries, and 50 kHz for some Eastern European countries.

The stations 115 may be mobile stations and/or stationary stations and may be distributed or deployed within a coverage area 120 of the transmitter 105. When a station 115 is a mobile station, it may also be referred to as a wireless station (STA), a wireless device, or a wireless terminal. The stations 115 may be configured to receive the RF signals 125 broadcast by the transmitter 105 and to process (e.g., demodulate) those signals to obtain an audio and/or data signal. When the transmitter 105 is part of a base station or an access point, one or more of the stations 115 may be configured to communicate bi-directionally with wireless communications networks (e.g., cellular networks, WLANs) supported by the base station or the access point.

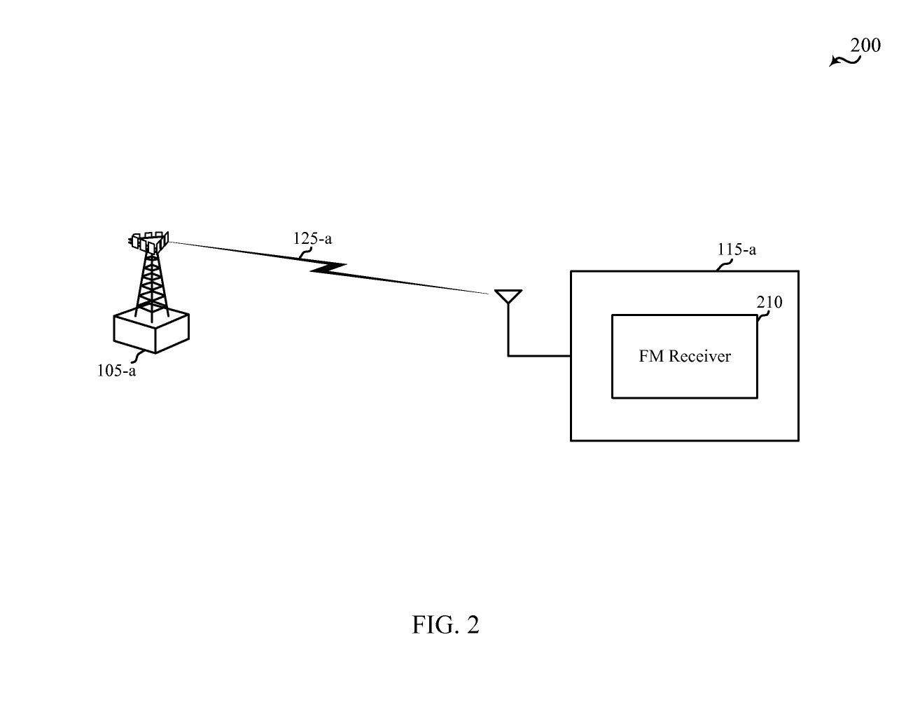

The transmitter 105 may be configured to operate in a particular country or region and may support RF signal transmission using a maximum frequency deviation or bandwidth that corresponds to that country or region. The stations 115, however, may be configured to support multiple maximum frequency deviations (i.e., configured for use in different countries or regions) and may be able to identify which bandwidth is supported by the transmitter 105 and adapt its operation accordingly (e.g., adapt coefficients of a channel filter in an FM receiver). FIGS. 2-11 described below provide additional details on various aspects of using an FM receiver that includes a channel filter that is adaptable to handle the maximum frequency deviation of different countries or regions.

FIG. 2 shows a diagram 200 in which a transmitter 105-a broadcasts RF signals 125-a with audio and/or data information to a station 115-a. The transmission is based on a particular maximum frequency deviation or bandwidth for the country or region in which the transmitter 105-a is located. The transmitter 105-a may be an example of the transmitter 105 in FIG. 1 and the station 115-a may be an example of the stations 115 also in FIG. 1.

The station 115-a may include an FM receiver 210 (e.g., digital FM receiver) that may be configured to process the RF signals 125-a to obtain the audio and/or data information by adapting a portion of the FM receiver 210 according to the particular maximum frequency deviation being used for transmission of the RF signals 125-a. The processing of the RF signals 125-a may include a channel filtering operation and a demodulation operation, which are used to produce signals for an audio decoder (not shown) and/or for an RDS or RBDS decoder (not shown) within the station 115-a. The channel filtering operation may depend on the maximum frequency deviation being used for transmission of the RF signals 125-a. When the bandwidth used in the channel filtering operation is different from the transmission bandwidth, which results in sub-optimal channel filtering, the FM receiver 210 may be configured to modify the bandwidth of the channel filtering operation to be the same or similar to the transmission bandwidth to improve the filtering performance.

In one example, the station 115-a may be configured (during operation and/or during manufacturing) to support maximum frequency deviations of 50 kHz, 75 kHz, and 100 kHz (as well as 22.5 kHz for receiver sensitivity tests). The station 115-a may also be configured to have a default or initial bandwidth value. In this example, the initial bandwidth supported is 50 kHz. The transmitter 105-a may transmit RF signals 125-a using a 75 kHz maximum frequency deviation. If the station 115-a were to perform its channel filtering operation at 50 kHz, the filtering performance would be sub-optimal. Instead, the station 115-a may identify (e.g., estimate) the maximum frequency deviation being used for transmission of the RF signals 125-a and may change the channel filtering operation (e.g., change filter coefficients) according to the maximum frequency deviation identified in order to improve filtering performance. In this instance, the station 115-a may adjust its operation to support a 75 kHz maximum frequency deviation like the one being used for transmission of the RF signals 125-a by the transmitter 105-a.

In another example, the station 115-a may be configured (during operation and/or during manufacturing) to support maximum frequency deviations of 50 kHz, 75 kHz, and 100 kHz (as well as 22.5 kHz for receiver sensitivity tests). The station 115-a may also be configured to have a default or initial bandwidth value. In this example, the initial bandwidth supported is 50 kHz. The transmitter 105-a may transmit RF signals 125-a using a 60 kHz maximum frequency deviation. If the station 115-a were to perform its channel filtering operation at 50 kHz, the filtering performance would be sub-optimal. Instead, the station 115-a may identify (e.g., estimate) the maximum frequency deviation being used for transmission of the RF signals 125-a and may change the channel filtering operation (e.g., change filter coefficients) according to the maximum frequency deviation identified in order to improve filtering performance. In this instance, the station 115-a does not support 60 kHz, but supports 50 kHz and 75 kHz. The station 115-a may then decide whether to continue its channel filtering operation based on 50 kHz or whether adapting its channel filtering operation to 75 kHz may improve performance. In some cases, the station 115-a may be configured to modify the 50 kHz operation or the 75 kHz operation to produce channel filtering performance that is nearly optimal for the 60 kHz being used by the transmitter 105-a.

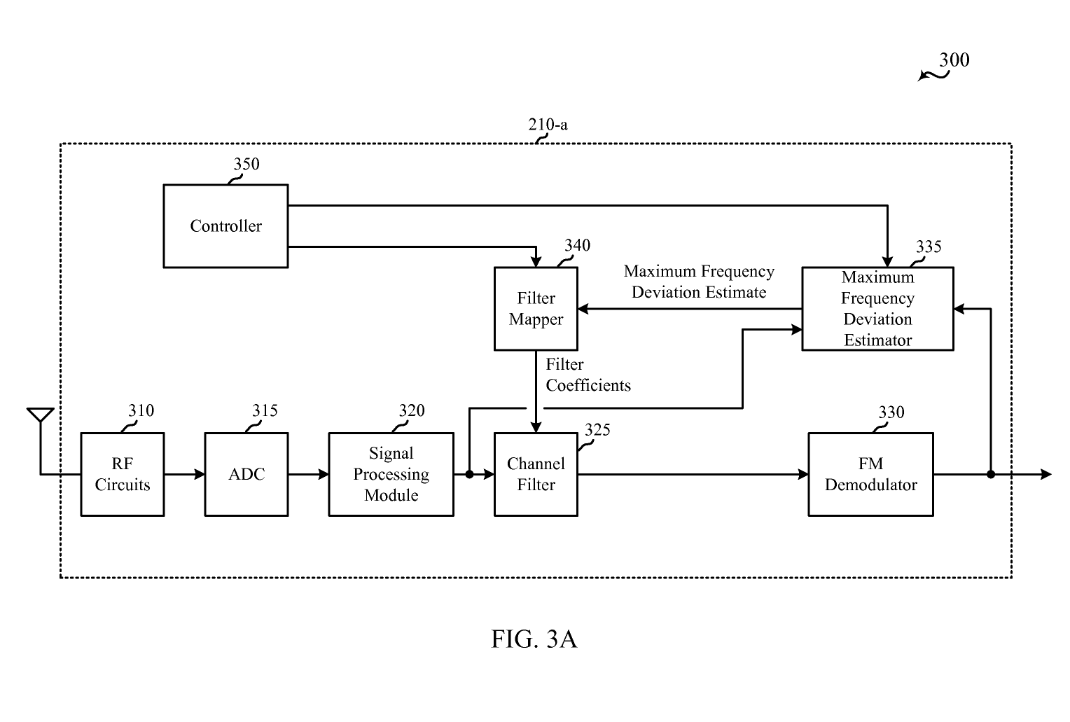

The examples described above with respect to FIG. 2 are provided by way of illustration and not of limitation. The station 115-a, and similar devices, may support more or fewer maximum frequency deviations from those described above. Additional details on various aspects of adapting a channel filtering operation in an FM receiver to handle multiple maximum frequency deviations are provided below with respect to FIGS. 3A-11.

Referring to FIG. 3A, a diagram 300 that includes an FM receiver 210-a that may be an example of the FM receiver 210 of FIG. 2 is shown. The FM receiver 210-a may include RF circuits 310, an analog-to-digital converter (ADC) 315, a signal processing module 320, a channel filter 325, and an FM demodulator 330. The FM receiver 210-a may also include a maximum frequency deviation estimator 335, a filter mapper 340, and a controller 350.

The FM receiver 210-a may be configured to receive RF signals having audio and/or data information and to perform front-end processing of those signals using the RF circuits 310, the ADC 315, and the signal processing module 320. The signal processing module 320, for example, may be configured to perform front-end filtering and/or removal of DC components, spur, and/or in-phase/quadrature (I/Q) imbalance.

The channel filter 325 may be configured to filter out-of-band noise for the received FM signals. The channel filter 325 may be adaptable or configurable. For example, the channel filter 325 may use filter coefficients that define the filtering operation and those filter coefficients may be adapted, adjusted, changed, or modified by the filter mapper 340 based at least in part on a maximum frequency deviation associated with the FM signals received by the FM receiver 210-a.

The FM demodulator 330 may be configured to demodulate the filtered FM signals produced by the channel filter 325. The output of the FM demodulator 330 may be provided to an audio decoder (not shown) and/or to RDS or RBDS decoder (not shown) for further processing. The output of the FM demodulator 330 may also be provided to the maximum frequency deviation estimator 335, which may be configured to estimate at least a maximum frequency deviation and to provide the estimate to the filter mapper 340. In some embodiments, the maximum frequency deviation estimator 335 may also be configured to estimate the variance of a maximum frequency deviation estimate from the input of a channel filter 325 or output of the FM demodulator 330 and to provide the variance to the filter mapper 340. The maximum frequency deviation estimator 335 may be configured to estimate the maximum frequency deviation in the time domain and/or in the frequency domain.

The filter mapper 340 may be configured to identify a set of filter coefficients to apply to the channel filter 325. The set of filter coefficients may be identified based at least on the maximum frequency deviation estimate from the maximum frequency deviation estimator 335. In some instances, the filter mapper 340 may also take into account the variance of a maximum frequency deviation estimate when one is provided by the maximum frequency deviation estimator 335. The filter mapper 340 may use the maximum frequency deviation estimate (and the variance) to compute a set of filter coefficients based on a formula. In another embodiment, the filter mapper 340 may use the maximum frequency deviation estimate (and the variance) to select one set of coefficients from multiple sets available in memory (e.g., in a look-up table (LUT)). Each of the sets available in memory may correspond to a particular maximum frequency deviation and may be pre-defined (e.g., computed off-line). A particular set may be selected for application to the channel filter 325 when the maximum frequency deviation estimate is the same or close to the maximum frequency deviation corresponding to that set.

The filter mapper 340 may be configured to modify the values of one or more coefficients in a set. For example, the number of sets available in memory may be limited and the maximum frequency deviation that is estimated by the maximum frequency deviation estimator 335 may not directly correspond to any of the sets available. In this case, the filter mapper 340 may select one of the sets (e.g., one with a corresponding maximum frequency deviation that is closest to the estimate) and may apply that set to the channel filter 325. In another example, the filter mapper 340 may instead modify the value of one or more of the coefficients in the selected set such that the performance of the modified set is optimal or near-optimal for the maximum frequency deviation estimated by the maximum frequency deviation estimator 335. The filter mapper 340 may be configured to perform a gradient descent-based optimization, or some other first-order or higher-order optimization algorithm, to select, adjust or adapt the values of one or more of the coefficients in a set.

The controller 350 may be configured to control and/or select operational features of the maximum frequency deviation estimator 335 and the filter mapper 340. For example, the controller 350 may be used to control whether the maximum frequency deviation estimator 335 is to generate the variance of a maximum frequency deviation estimate and/or whether the estimate of the maximum frequency deviation is performed in the time domain or in the frequency domain. In another example, the controller 350 may be used to control the selection and/or modification of filter coefficients for application to the channel filter 325.

In operation, a maximum frequency deviation of an FM broadcast signal received by the FM receiver 210-a is estimated by the maximum frequency deviation estimator 335 that monitors the input of a channel filter or output of the FM demodulator 330. The filter mapper 340 may adapt one or more (filter) coefficients of the channel filter 325 based at least in part on the maximum frequency deviation estimate provide by the maximum frequency deviation estimator 335. Adapting one or more coefficients of the channel filter 325 may include identifying a set of coefficients corresponding to the maximum frequency deviation estimate, and applying the set of coefficients to the channel filter 325. Identifying the set of coefficients corresponding to the maximum frequency deviation estimate may include selecting the set of coefficients from multiple sets of coefficients stored in memory (e.g., a LUT). In some embodiments, the multiple sets of coefficients may include one or more of a set of coefficients for 22.5 kHz (or ±22.5 kHz) frequency deviation, a set of coefficients for 50 (or ±50 kHz) kHz frequency deviation, a set of coefficients for 75 kHz (or ±75 kHz) frequency deviation, and a set of coefficients for 100 kHz (or ±100 kHz) frequency deviation.

In some embodiments, estimating the maximum frequency deviation of the FM broadcast signal by the maximum frequency deviation estimator 335 may include tracking minimum and maximum values of the out put of the FM demodulator 330. In other embodiments estimating the maximum frequency deviation of the FM broadcast signal by the maximum frequency deviation estimator 335 may include performing an FFT operation on the input of the FM demodulator 330, and determining the maximum frequency deviation from frequency information produced by the FFT operation.

In some embodiments, the adaptation of one or more coefficients of the channel filter 325 by the filter mapper 340 may include mapping the maximum frequency deviation to a set of coefficients, modifying a value of one or more of the set of coefficients, and applying the set of coefficients with the one or more modified values to the channel filter 325.

In one example of the operation described above, the FM receiver 210-a may be initially configured to operate with a maximum frequency deviation of 50 kHz (i.e., coefficients of the channel filter 325 are initially selected for a 50 kHz bandwidth). After processing the FM broadcast signal, the FM demodulator 330 may produce an output that is used by the maximum frequency deviation estimator 335 to determine an estimate of the maximum frequency deviation used for transmission of the FM broadcast signal. In this example the estimate is about 75 kHz. The maximum frequency deviation estimate is provided to the filter mapper 340, which in turn identifies a set of coefficients for the channel filter 325 to operate at a bandwidth of 75 kHz. The filter mapper 340 may then apply the identified set of coefficients to the channel filter 325 for processing of subsequent FM broadcast signals.

In another example of the operation described above, the FM receiver 210-a may be initially configured to operate with a maximum frequency deviation of 50 kHz (i.e., coefficients of the channel filter 325 are initially selected for a 50 kHz bandwidth). After processing the FM broadcast signal, the FM demodulator 330 may produce an output that is used by the maximum frequency deviation estimator 335 to determine an estimate of the maximum frequency deviation used for transmission of the FM broadcast signal. In this example the estimate is about 60 kHz. The maximum frequency deviation estimate is provided to the filter mapper 340. The filter mapper 340 may determine that none of the sets of coefficients available in memory corresponds to a bandwidth of 60 kHz. The filter mapper 340 may then identify a set that has a corresponding bandwidth that is close to the estimate (e.g., 50 kHz or 75 kHz) and that may provide the best performance. If the set corresponding to 50 kHz is selected, no change is needed to the filter coefficients of the channel filter 325 since it is already operating at that bandwidth. If the set corresponding to 75 kHz is selected, the filter mapper 340 may adapt the coefficients of the channel filter 325 to operate at the 75 kHz bandwidth.

In this example, after the filter mapper 340 identifies a set that has a corresponding bandwidth that is close to the estimate, the filter mapper 340 may then modify the value of one or more coefficients in that set such that the modified set operates closer to a 60 kHz bandwidth set instead of a 50 kHz or 75 kHz bandwidth set. In this regard, the filter mapper 340 may employ a gradient descent-based optimization to perform the modification.

In FIG. 3B, a diagram 300-a is shown that includes an FM receiver 210-b that may be an example of the FM receivers 210 and 210-a of FIGS. 2 and/or 3A. The FM receiver 210-b may include RF circuits 310-a, an ADC 315-a, a signal processing module 320-a, a channel filter 325-a, and an FM demodulator 330-a. The FM receiver 210-b may also include a maximum frequency deviation estimator 335-a, a filter mapper 340-a, and a controller 350-a. The components of the FM receiver 210-b may be the same or similar to the corresponding components of the FM receiver 210-a in FIG. 3A.

The FM receiver 210-b may also include a CNR estimator 355 and a pilot tone SNR estimator 360. The CNR estimator 355 may be configured to determine a signal quality metric of the baseband or intermediate frequency input to the channel filter 325-a. The pilot tone SNR estimator 360 may be configured to determine a signal quality metric of a pilot tone in the demodulated output from the FM demodulator 330-a. In one example, the signal quality metric may be signal strength (e.g., SNR or signal-to-interference-plus-noise ratio (SINR)). The signal quality metric determined by the CNR estimator 355 and/or the pilot tone SNR estimator 360 may be provided to the filter mapper 340-a, which may be configured to modify a value of one or more coefficients in a set based at least in part on the signal quality metrics received from the CNR estimator 355 and/or the pilot tone SNR estimator 360.

The operation of the FM receiver 210-b may be substantially similar to that of the FM receiver 210-a described above. However, in the operation of the FM receiver 210-b, identifying a set of coefficients corresponding to the maximum frequency deviation may include identifying a signal quality metric (e.g., CNR estimate, pilot tone SNR estimate), selecting the set of coefficients from multiple sets of coefficients stored in memory (e.g., LUT), and modifying a value of one or more of the set of coefficients based at least in part on the signal quality metric. Modifying a value of one or more of the set of coefficients based at least in part on the signal quality metric may include performing a gradient descent-based optimization (e.g., by filter mapper 340-a) on at least a portion of the set of coefficients.

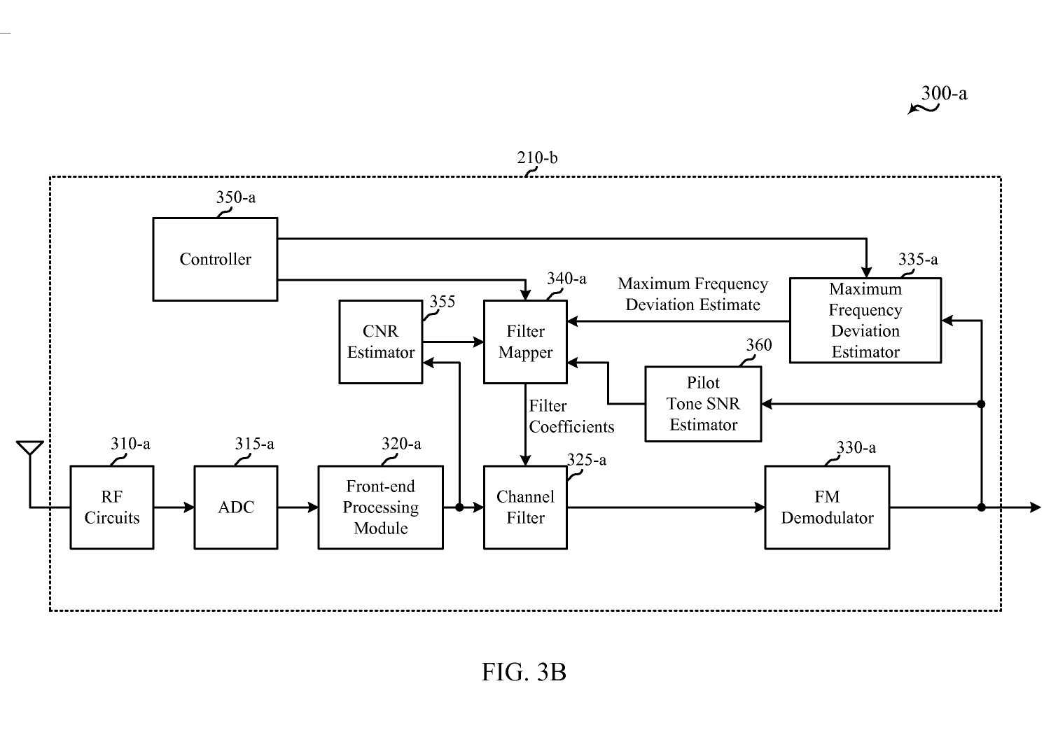

Referring to FIG. 4, a diagram 400 shows a maximum frequency deviation estimator 335-b that may be an example of the maximum frequency deviation estimators 335 and 335-a of FIGS. 3A and/or 3B. The maximum frequency deviation estimator 335-b may include a variance estimator for a maximum frequency deviation estimator 410. The maximum frequency deviation estimator 335-b may optionally include a maximum frequency deviation estimate variance estimator 420 and/or an FFT module 430.

The maximum frequency deviation estimator 410 may be configured to receive an output from an FM demodulator (e.g., FM demodulators 330, 330-a) and estimate the maximum frequency deviation of the FM demodulator output signal. The output from the FM demodulator may be an output that is typically provide to an audio decoder and/or to a RDS or RBDS decoder. The output from the FM demodulator may be modeled as follows:

$${x}_{r} [ k ] = {e}^{j ( 2 π {f}_{IF} \frac{k}{{f}_{s}} + 2 π \frac{{f}_{d}}{{f}_{s}} {\sum }_{n = 0}^{k} m [ n ] )}$$

where f_{IF}, fₛ, f_{d}, m[n], respectively represent the intermediate frequency, sampling frequency, maximum frequency deviation, and a message signal, and k and m represent the sample index. According to Carson's rule, the signal bandwidth for xᵣ[k] may be approximately 2(f_{d}+fₘ), where fₘ represents the highest frequency in the message signal m[n]. Therefore, there is a clear dependence of signal bandwidth on f_{d}. The maximum frequency deviation estimator 410 may estimate the maximum frequency deviation by tracking the minimum and maximum values of the output of the FM demodulator, which is a constant multiplied by f_{d} m[n].

The maximum frequency deviation estimate variance estimator 420 may be configured to receive an output from an FM demodulator (e.g., FM demodulators 330, 330-a) and determine the variance of the estimate of the corresponding maximum frequency deviation. The output from the FM demodulator used by the maximum frequency deviation estimate variance estimator 420 may be the same output used by the maximum frequency deviation estimator 410.

In some embodiments, the maximum frequency deviation estimator 335-b may estimate the maximum frequency deviation from the frequency domain characteristics of the input to a channel filter (e.g., channel filters 325, 325-a). In such instances, the FFT module 430 may be used to perform an FFT operation and convert the input to the channel filter to the frequency domain to then estimate the maximum frequency deviation.

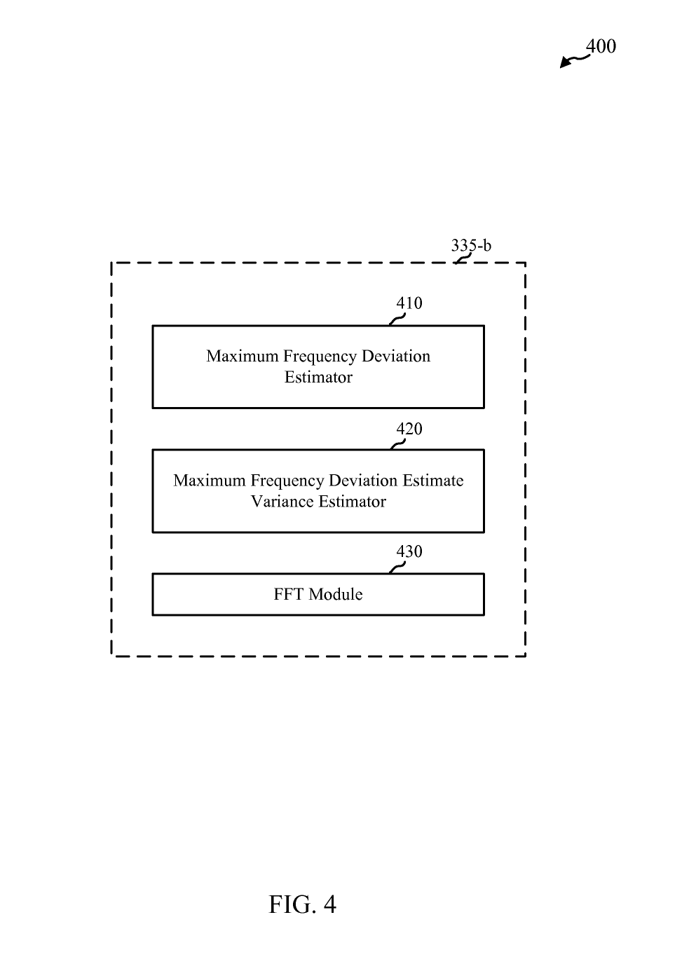

FIG. 5 shows a diagram 500 that includes a filter mapper 340-b that may be an example of the filter mapper 340 and 340-a of FIGS. 3A and/or 3B. The filter mapper 340-b may include a filter coefficient identifier and selector 510, a filter coefficient memory 520, and a filter coefficient modifier 530.

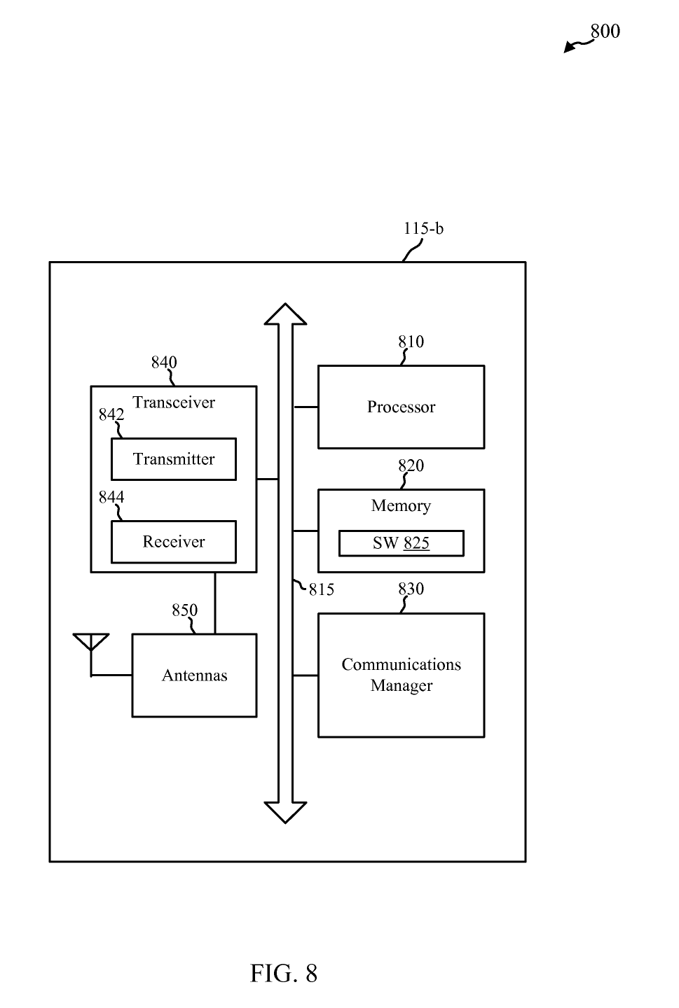

The filter coefficient identifier and selector 510 may be configured to perform various aspects described herein for identifying and/or selecting a set of coefficients to apply to a channel filter. In some embodiments, the filter coefficient identifier and selector 510 may compute a set of coefficients using a formula based at least in part on a maximum frequency deviation estimate and/or the variance of the maximum frequency deviation estimate. In other embodiments, the filter coefficient identifier and selector 510 may identify and/or select a set of coefficients from multiple sets of coefficients available (e.g., in the filter coefficient memory 520) based at least in part on a maximum frequency deviation estimate and/or the variance of the maximum frequency deviation estimate. The multiple sets of coefficients may be stored locally in the filter coefficient memory 520 and/or in a separate memory device (see e.g., memory 820 in FIG. 8).

The filter coefficient memory 520 may be configured for storage and/or access of sets of coefficients that can be applied to a channel filter to adjust or adapt the operation of the channel filter according to the maximum frequency deviation or bandwidth used in a particular country or region. In one example, the filter coefficient memory 520 may include a set of coefficients for 22.5 kHz frequency deviation, a set of coefficients for 50 kHz frequency deviation, a set of coefficients for 75 kHz frequency deviation, and/or a set of coefficients for 100 kHz frequency deviation. The filter coefficient memory 520 need not be so limited and in other examples more, fewer, and/or different sets may be available from the filter coefficient memory 520. The filter coefficient memory 520 may be configured as a LUT in which a set of coefficients is selected from the LUT by, for example, using the maximum frequency deviation estimate as an index value.

The filter coefficient modifier 530 may be configured to modify, adjust, or change the value of one or more coefficients in a set identified or selected by the filter coefficient identifier and selector 510. In some embodiments, the variance of a maximum frequency deviation estimate may be used to modify or adapt the values of coefficients in a set.

The filter coefficient modifier 530 may include a signal quality metric identifier 535 and a gradient descent module 540. The signal quality metric identifier 535 may be configured to receive signal quality metrics (e.g., CNR, SNR) corresponding to an intermediate frequency (IF) signal (e.g., input of the channel filter 325-a) and/or a pilot tone in a demodulated signal (e.g., output of FM demodulator 330-a). The signal quality metric identifier 535 may then use the signal quality metrics to modify or adapt the values of coefficients in a set. For example, when CNR or pilot tone SNR is low, the coefficients in the set may be modified to improve the system performance. The gradient descent module 540 may be configured to perform a gradient descent-based optimization, or some other first-order or higher-order optimization algorithm, to adjust or adapt the values of one or more of the coefficients in a set.

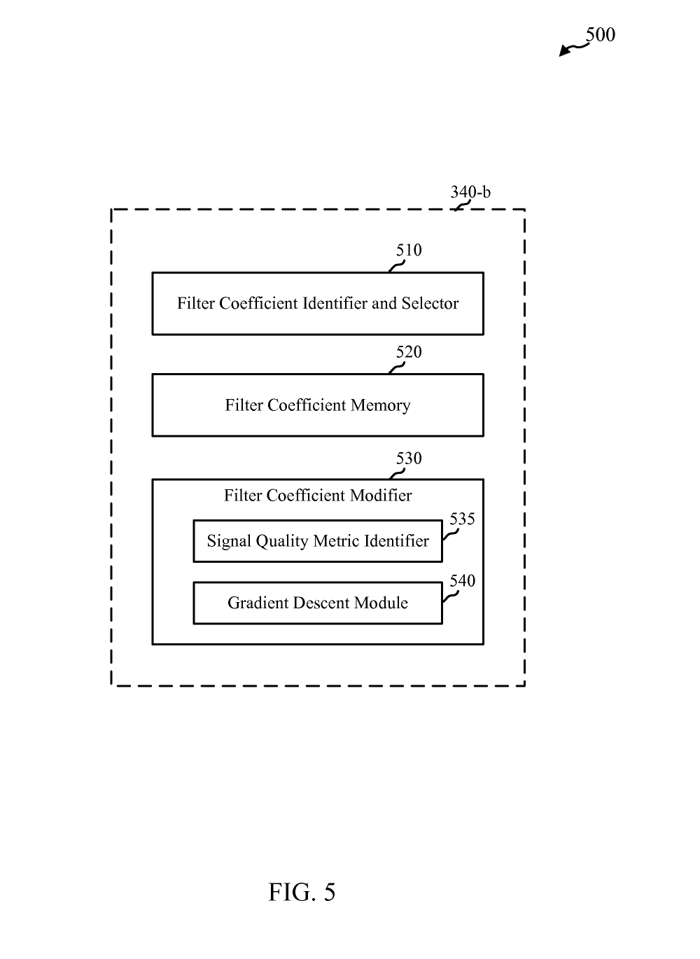

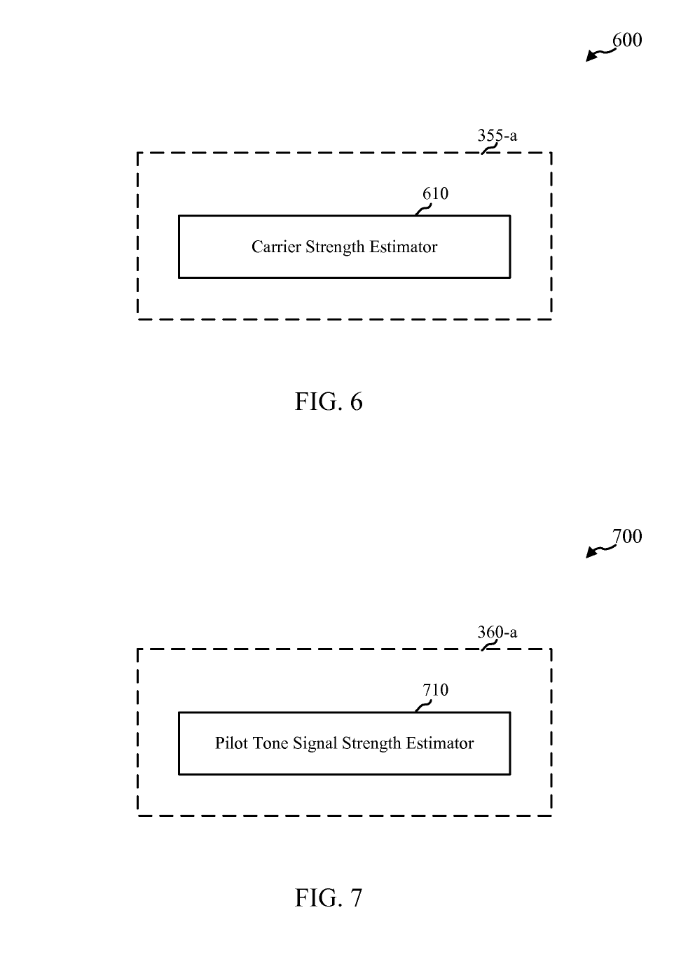

Referring to FIG. 6, a diagram 600 is shown that illustrates an CNR estimator 355-a that may be an example of the CNR estimator 355 of FIG. 3B. The CNR estimator 355-a may include an carrier strength estimator 610 that may be configured to determine or estimate a signal strength value (e.g., SNR, SINR) of an input of a channel filter (e.g., channel filter 325-a). FIG. 7 illustrates a diagram 700 that shows an pilot tone SNR estimator 360-a that may be an example of the pilot tone SNR estimator 360 of FIG. 3B. The pilot tone SNR estimator 360-a may include a pilot tone signal strength estimator 710 that may be configured to determine or estimate a signal strength value (e.g., SNR, SINR) of an output of an FM demodulator (e.g., FM demodulator 330-a).

FIG. 8 shows a diagram 800 that illustrates a terminal or station 115-b configured to receive FM broadcast signals and process those signals using a frequency deviation-dependent adaptive channel filter. The station 115-b may have various other configurations and may be included or be part of a personal computer (e.g., laptop computer, netbook computer, tablet computer, etc.), a cellular telephone, a PDA, a digital video recorder (DVR), an internet appliance, a gaming console, an e-reader, etc. The station 115-b may have an internal power supply (not shown), such as a small battery, to facilitate mobile operation. The station 115-b may be an example of the stations 115 and 115-a of FIGS. 1 and/or 2. The station 115-b may be configured to implement at least some of the features and functions described above with respect to FIGS. 1-7.

The station 115-b may include a processor 810, a memory 820, a transceiver 840, and antennas 850. The transceiver 840 may include a transmitter 842 and a receiver 844. The receiver 844 may be an example of the FM receivers 210, 210-a, and 210-b of FIGS. 2, 3A, and/or 3B. Each of these components may be in communication with each other, directly or indirectly, over one or more buses 815.

The memory 820 may include random access memory (RAM) and read-only memory (ROM). The memory 820 may store computer-readable, computer-executable software (SW) code 825 containing instructions that are configured to, when executed, cause the processor 810 to perform various functions described herein for handling wireless communications and/or processing of FM broadcast signals (e.g., FM broadcast signals received over VHF). Alternatively, the software code 825 may not be directly executable by the processor 810 but be configured to cause the computer (e.g., when compiled and executed) to perform functions described herein.

The processor 810 may include an intelligent hardware device, e.g., a central processing unit (CPU), a microcontroller, an ASIC, etc. The processor 810 may process information received through the transceiver 840 (e.g., via the receiver 844). The processor 810 may process information to be sent to the transceiver 840 for transmission through the antennas 850 (e.g., via the transmitter 842). The processor 810 may handle, alone or in connection with other components of the station 115-b, various aspects for handling wireless communications and/or processing of FM broadcast signals.

The transceiver 840 may be configured to receive RF signals from a transmitter (e.g., transmitter 105). Moreover, the transceiver 840 may be configured to communicate bi-directionally with a base station, access point, or other similar network device. The transceiver 840 may be implemented as one or more transmitters and one or more separate receivers. As described above, the transceiver 840 in this example is shown to include the transmitter 842 and the receiver 844. The transceiver 840 may support communications with a WLAN or Wi-Fi network, and/or with a cellular network. The transceiver 840 may include a modem configured to modulate the packets and provide the modulated packets to the antennas 850 for transmission, and to demodulate packets received from the antennas 850 (e.g., FM demodulators 330, 330-a).

According to the architecture of FIG. 8, the station 115-b may further include a communications manager 830. The communications manager 830 may manage communications with various network devices (e.g., base stations, access points) and/or the reception of FM broadcasts from an FM transmitter (e.g., transmitter 105). The communications manager 830 may be a component of the station 115-b in communication with some or all of the other components of the station 115-b over the one or more buses 815. Alternatively, functionality of the communications manager 830 may be implemented as a component of the transceiver 840, as a computer program product, and/or as one or more controller elements of the processor 810.

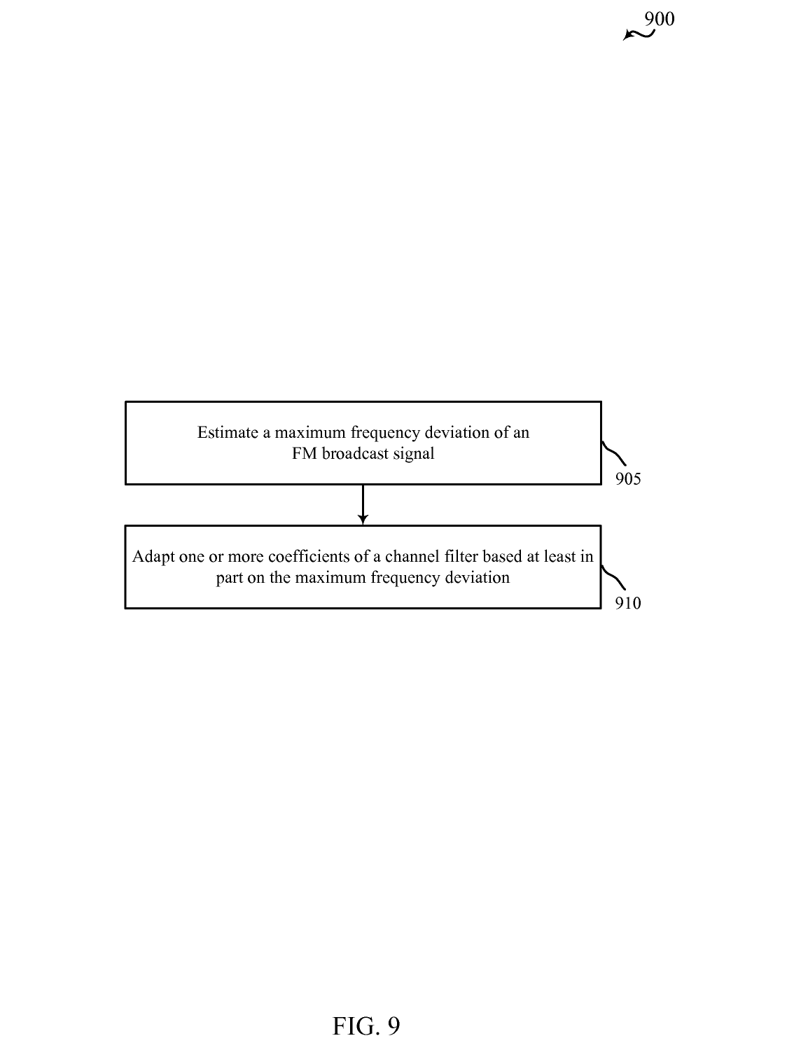

FIG. 9 is a flow chart illustrating an example of a method 900 for wireless communications in which an FM receiver with a frequency deviation-dependent adaptive channel filter is used for FM broadcasting. For clarity, the method 900 is described below with reference to one of the stations, receivers, devices, and modules shown in FIGS. 1, 2, 3A, 3B, 4, 5, 6, 7, and/or 8. In one embodiment, one of the stations may execute one or more sets of codes to control the functional elements of the station to perform the functions described below.

At block 905, a maximum frequency deviation of an FM broadcast signal is estimated (e.g., by maximum frequency deviation estimators 335, 335-a, 335-b) from an input of a filter (e.g., channel filters 325, 325-a) or output of a demodulator (e.g., FM demodulator 330, 330-a).

At block 910, one or more coefficients of a channel filter (e.g., channel filters 325, 325-a) are adapted (e.g., by filter mapper 340, 340-a, 340-b) based at least in part on the maximum frequency deviation estimate.

In some embodiments of the method 900, adapting one or more coefficients of a channel filter includes identifying a set of coefficients corresponding to the maximum frequency deviation estimate, and applying the set of coefficients to the channel filter. Identifying a set of coefficients corresponding to the maximum frequency deviation estimate may include selecting the set of coefficients from multiple sets of coefficients stored in memory (e.g., filter coefficient memory 520, memory 820). The multiple sets of coefficients may include one or more of a set of coefficients for 22.5 kHz frequency deviation, a set of coefficients for 50 kHz frequency deviation, a set of coefficients for 75 kHz frequency deviation, and a set of coefficients for 100 kHz frequency deviation. Identifying a set of coefficients corresponding to the maximum frequency deviation estimate may include identifying a signal quality metric (e.g., CNR, pilot tone SNR), selecting the set of coefficients from multiple sets of coefficients stored in memory (e.g., filter coefficient memory 520, memory 820), and modifying a value of one or more of the set of coefficients based at least in part on the signal quality metric. Modifying a value of one or more of the set of coefficients based at least in part on the signal quality metric may include performing a gradient descent-based optimization (e.g., by the gradient descent module 540) on at least a portion of the set of coefficients.

In some embodiments of the method 900, the method includes estimating a first signal strength (e.g., CNR) from an input of the channel filter (e.g., by CNR estimator 355), estimating a second signal strength (e.g., pilot tone SNR) from an output of the demodulator (e.g., by pilot tone SNR estimator 360), and adapting the one or more coefficients of the channel filter (e.g., by filter mappers 340, 340-a, 340-b) based at least in part on one or both of the first and second signal strengths.

In some embodiments of the method 900, estimating a maximum frequency deviation of an FM broadcast signal includes performing an FFT operation (e.g., FFT module 430) to the input of the channel filter, and determining the maximum frequency deviation from frequency information produced by the FFT operation. The method may include estimating the variance of a maximum frequency deviation estimate (e.g., maximum frequency deviation estimate variance estimator 420) from the input of the channel filter, where the one or more coefficients of the channel filter are adapted based at least in part on the maximum frequency deviation and the variance of the maximum frequency deviation estimate.

In some embodiments of the method 900, adapting one or more coefficients of a channel filter includes mapping the maximum frequency deviation to a set of coefficients, modifying (e.g., by filter coefficient modifier 530) a value of one or more of the set of coefficients, and applying the set of coefficients with the one or more modified values to the channel filter.

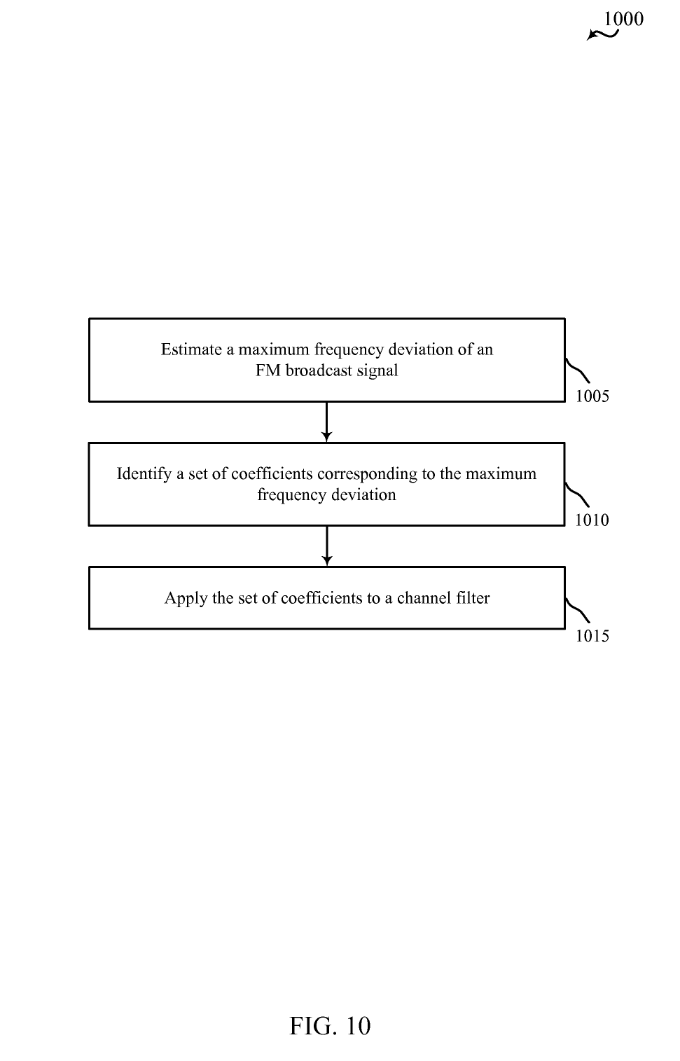

FIG. 10 is a flow chart illustrating an example of a method 1000 for wireless communications in which an FM receiver with a frequency deviation-dependent adaptive channel filter is used for FM broadcasting. For clarity, the method 1000 is described below with reference to one of the stations, receivers, devices, and modules shown in FIGS. 1, 2, 3A, 3B, 4, 5, 6, 7, and/or 8. In one embodiment, one of the stations may execute one or more sets of codes to control the functional elements of the station to perform the functions described below.

At block 1005, a maximum frequency deviation of an FM broadcast signal is estimated (e.g., by maximum frequency deviation estimators 335, 335-a, 335-b) from an input of a filter (e.g., channel filters 325, 325-a) or output of a demodulator (e.g., FM demodulator 330, 330-a).

At block 1010, a set of coefficients corresponding to the maximum frequency deviation are identified (e.g., by filter mappers 340, 340-a, 340-b, filter coefficient identifier and selector 510).

At block 1015, the set of coefficients are applied (by filter mappers 340, 340-a, 340-b) to a channel filter (e.g., channel filters 325, 325-a).

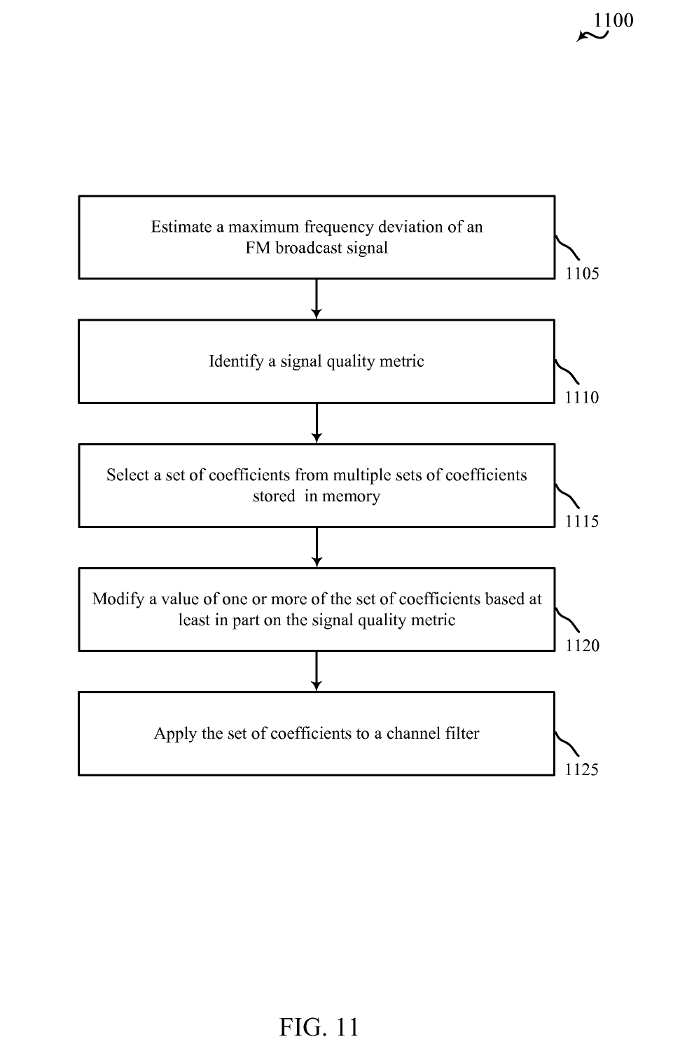

FIG. 11 is a flow chart illustrating an example of a method 1100 for wireless communications in which an FM receiver with a frequency deviation-dependent adaptive channel filter is used for FM broadcasting. For clarity, the method 1100 is described below with reference to one of the stations, receivers, devices, and modules shown in FIGS. 1, 2, 3A, 3B, 4, 5, 6, 7, and/or 8. In one embodiment, one of the stations may execute one or more sets of codes to control the functional elements of the station to perform the functions described below.

At block 1105, a maximum frequency deviation of an FM broadcast signal is estimated (e.g., by maximum frequency deviation estimators 335, 335-a, 335-b) from an input of a filter (e.g., channel filters 325, 325-a) or output of a demodulator (e.g., FM demodulator 330, 330-a).

At block 1110, a signal quality metric (e.g., CNR, pilot tone SNR) is identified (e.g., by signal quality metric identifier 535).

At block 1115, a set of coefficients is selected (e.g., by filter coefficient identifier and selector 510) from multiple sets of coefficients stored in memory (e.g., filter coefficient memory 520, memory 820).

At block 1120, a value of one or more of he set of coefficients is modified (e.g., by filter coefficient modifier 530) based at least in part on the signal quality metric.

At block 1125, the set of coefficients are applied (by filter mappers 340, 340-a, 340-b) to a channel filter (e.g., channel filters 325, 325-a).

Thus, the methods 900, 1000, and 1100 may provide for wireless communications. It should be noted that each of the methods 900, 1000, and 1100 is just one implementation and that the operations of the methods 900, 1000, and 1100 may be rearranged or otherwise modified such that other implementations are possible. In some instances, the operations of two or more of the methods 900, 1000, and 1100 may be combined to produce other implementations.

The detailed description set forth above in connection with the appended drawings describes exemplary embodiments and does not represent the only embodiments that may be implemented or that are within the scope of the claims. The term “exemplary” used throughout this description means “serving as an example, instance, or illustration,” and not “preferred” or “advantageous over other embodiments.” The detailed description includes specific details for the purpose of providing an understanding of the described techniques. These techniques, however, may be practiced without these specific details. In some instances, well-known structures and devices are shown in block diagram form in order to avoid obscuring the concepts of the described embodiments.

Information and signals may be represented using any of a variety of different technologies and techniques. For example, data, instructions, commands, information, signals, bits, symbols, and chips that may be referenced throughout the above description may be represented by voltages, currents, electromagnetic waves, magnetic fields or particles, optical fields or particles, or any combination thereof.

The various illustrative blocks and modules described in connection with the disclosure herein may be implemented or performed with a general-purpose processor, a digital signal processor (DSP), an application specific integrated circuit (ASIC), a field programmable gate array (FPGA) or other programmable logic device, discrete gate or transistor logic, discrete hardware components, or any combination thereof designed to perform the functions described herein. A general-purpose processor may be a microprocessor, but in the alternative, the processor may be any conventional processor, controller, microcontroller, or state machine. A processor may also be implemented as a combination of computing devices, e.g., a combination of a DSP and a microprocessor, multiple microprocessors, one or more microprocessors in conjunction with a DSP core, or any other such configuration.

The functions described herein may be implemented in hardware, software executed by a processor, firmware, or any combination thereof. If implemented in software executed by a processor, the functions may be stored on or transmitted over as one or more instructions or code on a computer-readable medium. Other examples and implementations are within the scope and spirit of the disclosure and appended claims. For example, due to the nature of software, functions described above can be implemented using software executed by a processor, hardware, firmware, hardwiring, or combinations of any of these. Features implementing functions may also be physically located at various positions, including being distributed such that portions of functions are implemented at different physical locations. Also, as used herein, including in the claims, “or” as used in a list of items prefaced by “at least one of” indicates a disjunctive list such that, for example, a list of “at least one of A, B, or C” means A or B or C or AB or AC or BC or ABC (i.e., A and B and C).

Computer-readable media includes both computer storage media and communication media including any medium that facilitates transfer of a computer program from one place to another. A storage medium may be any available medium that can be accessed by a general purpose or special purpose computer. By way of example, and not limitation, computer-readable media can comprise RAM, ROM, EEPROM, CD-ROM or other optical disk storage, magnetic disk storage or other magnetic storage devices, or any other medium that can be used to carry or store desired program code means in the form of instructions or data structures and that can be accessed by a general-purpose or special-purpose computer, or a general-purpose or special-purpose processor. Also, any connection is properly termed a computer-readable medium. For example, if the software is transmitted from a website, server, or other remote source using a coaxial cable, fiber optic cable, twisted pair, digital subscriber line (DSL), or wireless technologies such as infrared, radio, and microwave, then the coaxial cable, fiber optic cable, twisted pair, DSL, or wireless technologies such as infrared, radio, and microwave are included in the definition of medium. Disk and disc, as used herein, include compact disc (CD), laser disc, optical disc, digital versatile disc (DVD), floppy disk and blu-ray disc where disks usually reproduce data magnetically, while discs reproduce data optically with lasers. Combinations of the above are also included within the scope of computer-readable media.

The previous description of the disclosure is provided to enable a person skilled in the art to make or use the disclosure. Various modifications to the disclosure will be readily apparent to those skilled in the art, and the generic principles defined herein may be applied to other variations without departing from the spirit or scope of the disclosure. Throughout this disclosure the term “example” or “exemplary” indicates an example or instance and does not imply or require any preference for the noted example. Thus, the disclosure is not to be limited to the examples and designs described herein but is to be accorded the widest scope consistent with the principles and novel features disclosed herein.

What is claimed is:

1. A method for wireless communications, comprising:
estimating a maximum frequency deviation of a frequency-modulated (FM) broadcast signal; and
adapting one or more coefficients of a channel filter based at least in part on the maximum frequency deviation.

2. The method of claim 1, wherein adapting one or more coefficients of a channel filter comprises:
identifying a set of coefficients corresponding to the maximum frequency deviation; and
applying the set of coefficients to the channel filter.

3. The method of claim 2, wherein identifying a set of coefficients corresponding to the maximum frequency deviation comprises selecting the set of coefficients from multiple sets of coefficients stored in memory.

4. The method of claim 3, wherein the multiple sets of coefficients comprise one or more of:
a set of coefficients for 22.5 kilohertz (kHz) maximum frequency deviation;
a set of coefficients for 50 kHz maximum frequency deviation;
a set of coefficients for 75 kHz maximum frequency deviation; and
a set of coefficients for 100 kHz maximum frequency deviation.

5. The method of claim 2, wherein identifying a set of coefficients corresponding to the maximum frequency deviation comprises:
identifying a signal quality metric;
selecting the set of coefficients from multiple sets of coefficients stored in memory; and
modifying a value of one or more of the set of coefficients based at least in part on the signal quality metric.

6. The method of claim 5, wherein modifying a value of one or more of the set of coefficients based at least in part on the signal quality metric comprises performing a gradient descent-based optimization on at least a portion of the set of coefficients.

7. The method of claim 1, further comprising:
estimating a first signal strength of a carrier from an input of the channel filter;
estimating a second signal strength of a pilot tone from an output of a demodulator; and
adapting the one or more coefficients of the channel filter based at least in part on one or both of the first and second signal strengths.

8. An apparatus for wireless communications, comprising:
means for estimating a maximum frequency deviation of a frequency-modulated (FM) broadcast signal; and
means for adapting one or more coefficients of a channel filter based at least in part on the maximum frequency deviation.

9. The apparatus of claim 8, wherein the means for adapting one or more coefficients of a channel filter comprises:
means for identifying a set of coefficients corresponding to the maximum frequency deviation; and
means for applying the set of coefficients to the channel filter.

10. The apparatus of claim 9, wherein the means for identifying a set of coefficients corresponding to the maximum frequency deviation comprises means for selecting the set of coefficients from multiple sets of coefficients stored in memory.

11. The apparatus of claim 10, wherein the multiple sets of coefficients comprise one or more of:
a set of coefficients for 22.5 kilohertz (kHz) maximum frequency deviation;
a set of coefficients for 50 kHz maximum frequency deviation;
a set of coefficients for 75 kHz maximum frequency deviation; and
a set of coefficients for 100 kHz maximum frequency deviation.

12. The apparatus of claim 9, wherein the means for identifying a set of coefficients corresponding to the maximum frequency deviation comprises:
means for identifying a signal quality metric;
means for selecting the set of coefficients from multiple sets of coefficients stored in memory; and
means for modifying a value of one or more of the set of coefficients based at least in part on the signal quality metric.

13. The apparatus of claim 12, wherein the means for modifying a value of one or more of the set of coefficients based at least in part on the signal quality metric comprises means for performing a gradient descent-based optimization on at least a portion of the set of coefficients.

14. The apparatus of claim 8, further comprising:
means for estimating a first signal strength of a carrier from an input of the channel filter;
means for estimating a second signal strength of a pilot tone from an output of a demodulator; and
means for adapting the one or more coefficients of the channel filter based at least in part on one or both of the first and second signal strengths.

15. An apparatus for wireless communications, comprising:
a processor;
memory in electronic communication with the processor; and
instructions stored in the memory, the instructions being executable by the processor to:
estimate a maximum frequency deviation of a frequency-modulated (FM) broadcast signal; and
adapt one or more coefficients of a channel filter based at least in part on the maximum frequency deviation.

16. The apparatus of claim 15, wherein the instructions executable by the processor to adapt one or more coefficients of a channel filter comprise instructions executable by the processor to:
identify a set of coefficients corresponding to the maximum frequency deviation; and
apply the set of coefficients to the channel filter.

17. The apparatus of claim 16, wherein the instructions executable by the processor to identify a set of coefficients corresponding to the maximum frequency deviation comprise instructions executable by the processor to select the set of coefficients from multiple sets of coefficients stored in memory.

18. The apparatus of claim 17, wherein the multiple sets of coefficients comprise one or more of:
a set of coefficients for 22.5 kilohertz (kHz) maximum frequency deviation;
a set of coefficients for 50 kHz maximum frequency deviation;
a set of coefficients for 75 kHz maximum frequency deviation; and
a set of coefficients for 100 kHz maximum frequency deviation.

19. The apparatus of claim 16, wherein the instructions executable by the processor to identify a set of coefficients corresponding to the maximum frequency deviation comprise instructions executable by the processor to:
identify a signal quality metric;
select the set of coefficients from multiple sets of coefficients stored in memory; and
modify a value of one or more of the set of coefficients based at least in part on the signal quality metric.

20. The apparatus of claim 15, wherein the instructions are executable by the processor to:
estimate a first signal strength of a carrier from an input of the channel filter;
estimate a second signal strength of a pilot tone from an output of the demodulator; and
adapt the one or more coefficients of the channel filter based at least in part on one or both of the first and second signal strengths.
